(19) United States
(12) Patent Application Publication
(10) Pub. No.: US 2008/0173136 A1
(43) Pub. Date: Jul. 24, 2008

(54) Container lid opener

(76) Inventor: Young Dong Kim, Sunnyvale, CA (US)

Correspondence Address: BUCHANAN, INGERSOLL & ROONEY PC, POST OFFICE BOX 1404, ALEXANDRIA, VA, 22313-1404, US

(21) Appl. No.: 11/657,506

(22) Filed: Jan. 23, 2007

(51) Int. Cl. B67B 7/16

(52) U.S. Cl. 81/3.55

(57) ABSTRACT

Device for opening container lids. The device includes a rod that has an axial direction and a loop formed at one end of the rod. The device also includes a flange that has first and second ends, wherein the first end is attached to the other end of the rod at a predetermined angle with respect to the axial direction, and a curved tip is formed at the second end of the rod. The user holds the loop and a portion of the rod to repeatedly apply leverage force to a lid of a container and thereby to pry the lid from the container.

### BACKGROUND OF THE INVENTION

The present invention generally relates to hand tools, and more particularly to openers used for removing covers or lids from containers.

Can openers, bucket openers or pail openers of many types and varieties are known. However, some openers have multiple and/or moving parts to result high manufacturing costs and require precautions in use. Others, including hand tools, require some degree of experience to properly pry a lid from its container. FIGS. 1 and 2 show a typical hand tool for prying a lid from a container. As depicted, the tool or opener 10 includes: a handle portion 14 having a flat portion or thumb rest 16 and a loop 18; and a tip 12 that is commonly inserted into a space formed between the lid's rim and the container in use. Upon insertion, the handle portion 14 is pushed downwardly in a radial direction of the container to apply a leverage force and thereby to make a slight gap between the lid's rim and the container. Subsequently, the opener 10 is moved along the circumference of the container while the tip 12 remains in the gap, and the similar leverage force is applied to further open the gap. The user of the opener 10 repeats these steps along the entire circumference of the container until the lid is completely separated from the container. However, during the repetition, the user may inadvertently apply excessive downward force to result in the tipping of the container and spilling the contents therein. Also, quite often, the tip is disengaged from the gap during the repetition, making the tip fail to catch the lid’ rim during the leverage motion, which can result personal injury to the user.

### SUMMARY OF THE INVENTION

In one embodiment, a container lid opening tool includes: a rod having an axial direction; a loop formed at one end of the rod; a flange having first and second ends, the first end being attached to the other end of the rod at a predetermined angle with respect to the axial direction; and a curved tip formed at the second end of said flange. The user holds the loop and a portion of the rod to repeatedly apply leverage force to a lid of a container and thereby to pry the lid from the container.

In another embodiment, a container lid opening tool includes: a rod having an axial direction; a handle enclosing one end portion of the rod; a flange having first and second ends, the first end being attached to the other end of the rod at a predetermined angle with respect to the axial direction; and a curved tip formed at the second end of the flange. The user holds the handle a portion of the rod to repeatedly apply leverage force to a lid of a container and thereby to pry the lid from the container.

These and other features, aspects and advantages of the present invention will become better understood with reference to the following drawings, description and claims.

### BRIEF DESCRIPTION OF THE DRAWINGS

FIG. 1 shows a schematic top plan view of a conventional lid opener;

FIG. 2 shows a schematic side view of the lid opener in FIG. 1;

FIG. 3 shows a schematic perspective view of an opener in accordance with the present invention;

FIG. 4 shows a schematic top plan view of the opener in FIG. 3;

FIG. 5 shows a schematic side view of the opener in FIG. 3;

FIG. 6 shows a schematic end view of the opener in FIG. 3;

FIG. 7 shows a typical use of the opener in FIG. 3;

FIG. 8 shows a schematic cross sectional view of the opener of FIG. 3 in use, taken along the line 8-8 (FIG. 7);

FIG. 9A shows a schematic cross sectional view of a container and the opener of FIG. 3, illustrating a typical use of the opener;

FIG. 9B shows a schematic side cut-away view of the container and opener in use;

FIG. 10 shows a schematic perspective view of another embodiment of a tip of an opener in accordance with the present invention;

FIG. 11 shows a schematic diagram of another embodiment of a loop of an opener in accordance with the present invention;

FIG. 12 shows a schematic cross sectional view of the loop in FIG. 11, taken along the line 12-12 (FIG. 11);

FIG. 13 shows a schematic diagram of yet another embodiment of a loop of an opener in accordance with the present invention;

FIG. 14 shows a schematic diagram of still another embodiment of a loop of an opener in accordance with the present invention;

FIG. 15 shows a schematic diagram of another embodiment of an opener in accordance with the present invention;

FIG. 16 shows a schematic diagram of yet another embodiment of an opener in accordance with the present invention;

FIG. 17 shows a schematic diagram of further another embodiment of an opener in accordance with the present invention;

FIG. 18 shows a schematic diagram of yet further another embodiment of an opener in accordance with the present invention; and

FIG. 19 shows a schematic diagram of still further another embodiment of an opener in accordance with the present invention.

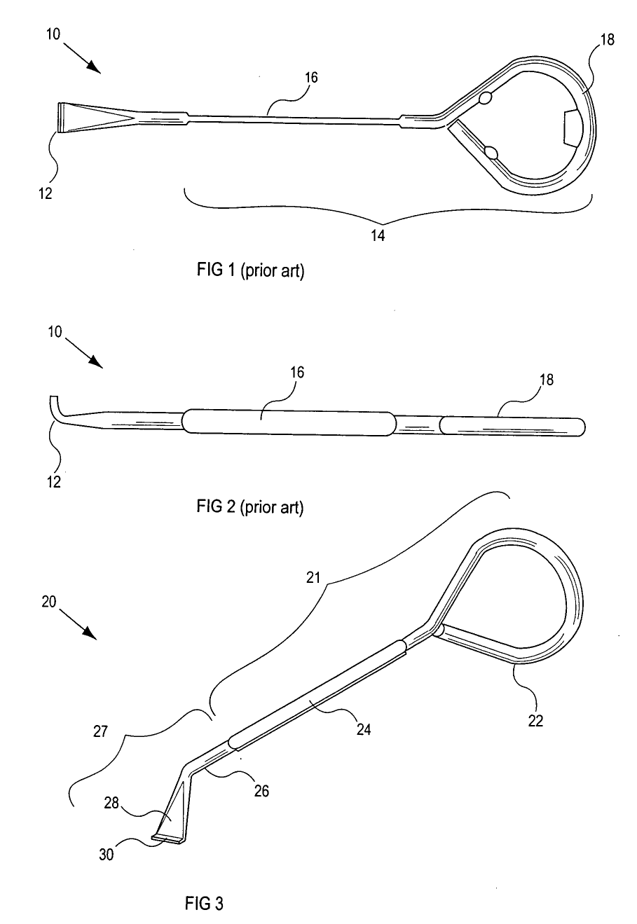

### DETAILED DESCRIPTION OF THE DISCLOSURE

The following detailed description is of the best currently contemplated modes of carrying out the invention. The description is not to be taken in a limiting sense, but is made merely for the purpose of illustrating the general principles of the invention, since the scope of the invention is best defined by the appended claims.

FIGS. 3-6 show respectively schematic perspective, top plan, side, and end views of a lid opener 20 in accordance with the present invention. As depicted, the opener 20 includes a handle portion 21 and a head portion 27. The handle portion 21 includes a loop 22 having a pear- or somewhat oval-shape and a flat portion or thumb rest 24 that is preferably in contact with a thumb or the like of the user to enhance manual securement of the opener in use. The thumb rest 24 also enhances bending strength and may include engraved or raised impression of the manufacturer's name/logo or other ornamental decoration. The loop 22 is formed on a plane, which is referred to as a loop plane hereinafter. An axis 23 that is positioned along an axial direction of the thumb rest 26 is referred to as a handle axis hereinafter. The head portion 27 includes a rod 26, a flange 28, and a tip 30, wherein the rod 26 is generally in line with the handle axis 23 while the flange 28 is tilted with respect to the handle axis 23 by a suitable angle θ, preferably 45°. The flange 28 has a tapered shape and substantially remains on the loop plane while the tip 30 is slightly bent out of the loop plane.

It is noted that the flat surface of the thumb rest 16 of the conventional opener 10 in FIG. 1 is positioned normal to the paper or the loop plane. In contrast, as depicted in FIG. 3, the flat surface of the thumb rest 24 of the opener 20 is generally parallel to the paper or the loop plane. As such, the user can grip the handle portion 21 in the same manner as he grips the handle of a conventional knife, providing an enhanced grip and ergonomic comfort for the user.

The opener 20 is dimensioned to conveniently fit within the palm of a hand thereby optimizing both comfort and strength of the user during the use thereof. The opener 20 may be formed of rigid material, preferably metal. Metal provides the necessary strength and is economic for manufacturing. Preferably, the entire portion of the opener 20 may be formed of a metal rod, i.e., the loop 22 can be formed by bending one end of the metal rod, the thumb rest 24 may be formed by flattening a portion of the metal rod, and the flange 28 and tip 30 may be formed by flattening and bending the other end the rod.

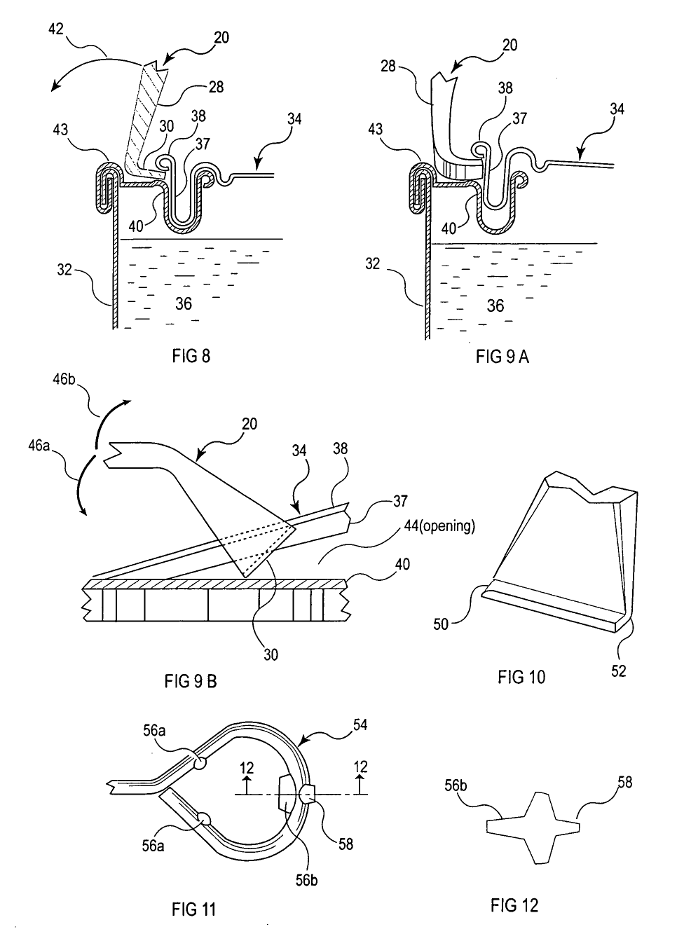

FIG. 7 shows a typical use of the opener 20 to pry a lid 34 from a container 32, such as paint can. As a first step to pry the lid 34, the curved tip 30 of the opener 20 is engaged into a space formed between the lid 34 and container 32. FIG. 8 shows a schematic cross sectional view of the opener 20 in use, taken along the line 8-8 in FIG. 7. As depicted, a typical container 32 includes an outer rim 43 and an inner rim 40 having a generally U-shaped cross section. The lid 34 includes a U-shaped outer rim 37 that tightly fits into the U-shaped inner rim 40 and thereby to seal the contents 36 in the container 32 from the atmosphere. In the first step to pry the lid 34 from the container 32, the tip 30 of the opener 20 is pushed into a space formed between a lip 38 of the outer rim 37 and the inner rim 40, engaging the tip into the space. Upon engagement of the tip 30, the flange 28 is rotated in the direction of an arrow 42 to leverage a portion of the lid 37 open.

Once a portion of the lid 34 is open, as a second step, the tip 30 is inserted into the opening and tilted as shown in FIGS. 9A and 9B. FIG. 9A shows a schematic cross sectional view of the container 32 and the opener 20, illustrating the second step in using the opener 20. FIG. 9B, taken along a radial direction of the container, corresponds to FIG. 9A and shows a schematic side cut-away view of the 32 container and the opener 20. As depicted, the tip 30 of the opener is inserted into an opening 44 formed between the lip 38 and the inner rim 40 of the container 32. Then, the user pushes the opener 20 downward in the direction of an arrow 46a to increase the opening 44, using the bottom edge of the tip 30 as a fulcrum to lift the top corner of the tip that catches the lip 38. Subsequently, the user moves the opener along the circumferential direction of the container 32 with the tip 30 remain inserted in the opening 44 and simultaneously positions the opener 20 slightly upward in the direction of an arrow 46b. The user repeats the motions along the arrows 46a, 46b while moving the opener 20 along the circumferential direction of the container until the lid 34 is pried completed from the container 32.

It is noted that the conventional opener 10 is operated by repeating the leverage motion in the direction of the arrow 42 (FIG. 8), i.e., in the radial direction of the container. As the user needs to move the opener 10 along the circumferential direction of the container between two consecutive leverage motions, the user needs to alternately perform two types of motions that are oriented perpendicular to each other, which decreases the efficiency in opening the lid and increases the chance of disengagement between the opener 10 and gap 44. In contrast, the user of the opener 20 repeats the leverage motion in the direction of arrows 46a, 46b (FIG. 9), which is substantially in a plane tangential to the circumference of the rim 40. As the user moves the opener 20 along the circumferential direction of the rim 40 between two consecutive leverage motions, the user alternately performs two types of motions in one plane, providing enhanced opening efficiency for the user. Also, the user holds the opener 20 in a similar way to hold the handle of a conventional knife, which provides enhanced grip and ergonomic comfort for the user and reduces the chance of disengagement between the tip 30 and the gap 44 during operation.

As discussed in conjunction with FIGS. 9A and 9B, the bottom edge of the tip 30 functions as a fulcrum while the top edge of the tip lifts up the lip 38. To reduce damages on the lip 38 due to its contact with the top edge of the tip during the leverage motion, an edge of the tip can be rounded. FIG. 10 shows a schematic perspective view of another embodiment of a tip in accordance with the present invention. As depicted, an edge or corner 50 of a tip 52 is rounded so that, when used in place of the tip 30, the damages on the lid can be reduced and thereby the lid can effectively reseal the container for storage of the remaining contents. Alternatively, the other edge or both edges of the tip 52 can be rounded.

The opener 20 can have additional functions, such as bottle opener and screw driver. FIG. 11 shows a schematic diagram of another embodiment of a loop in accordance with the present invention. FIG. 12 shows a schematic cross sectional view of the loop in FIG. 11, taken along the line 12-12 (FIG. 11). As depicted, the loop 54 has optional components, 56 and 58. The protrusion components 56a-56b are dimensioned to receive a portion of a beverage cap, such as a crown cap. The protrusion 58 is dimensioned to function as a screw driver.

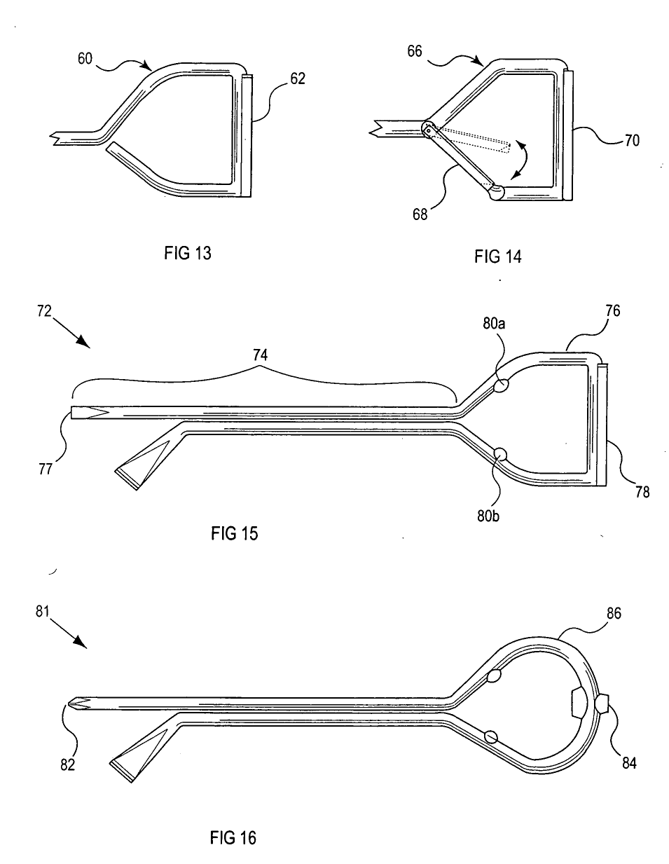

FIG. 13 shows a schematic diagram of yet another embodiment of a loop in accordance with the present invention. As depicted, the loop 60 optionally includes a scraper 62 for scraping flat surface to remove paint or the like applied thereto. Optionally, a beverage cap opener can be also implemented in the loop 60.

FIG. 14 shows a schematic diagram of still another embodiment of a loop in accordance with the present invention. As depicted, the loop 66 includes a snap 68, wherein the snap 68 may be conventional trigger, spring, or bolt type. The loop 66 may optionally include a scraper 70. Alternatively, the loop 66 may include a protrusion similar to the protrusion 58 in FIG. 11 in place of the scraper 70.

FIG. 15 shows a schematic diagram of another embodiment of an opener in accordance with the present invention. As depicted, the opener 72 is similar to the opener 20 in FIG. 3 with the differences that 1) one end of the loop 76 extends toward the head portion so that the opener 72 has an additional rod 74; 2) the loop 76 includes optional protrusions or components 78 and 80a; and 3) the opener 72 does not include a thumb rest. The components 78 and 80a may be used as beverage opener, while the component 78 can be also used as a scrapper. The rod 74 has a tip 77 shaped as a screw driver for slotted head screws or Phillips head screws.

FIG. 16 shows a schematic diagram of yet another embodiment of an opener in accordance with the present invention. As depicted, the opener 81 is similar to that in FIG. 15, with the differences that a protrusion 84 shaped as a screw driver is used in place of the scraper 78 and that the loop 86 has an oval shape. It is noted that the embodiments 72 and 81 may have various optional configurations described in FIGS. 10-13. For instance, the loop 76 may include a snap in place of the beverage opener 80a-80b. For another instance, the loop 86 may include a scraper in place of the screw driver 84.

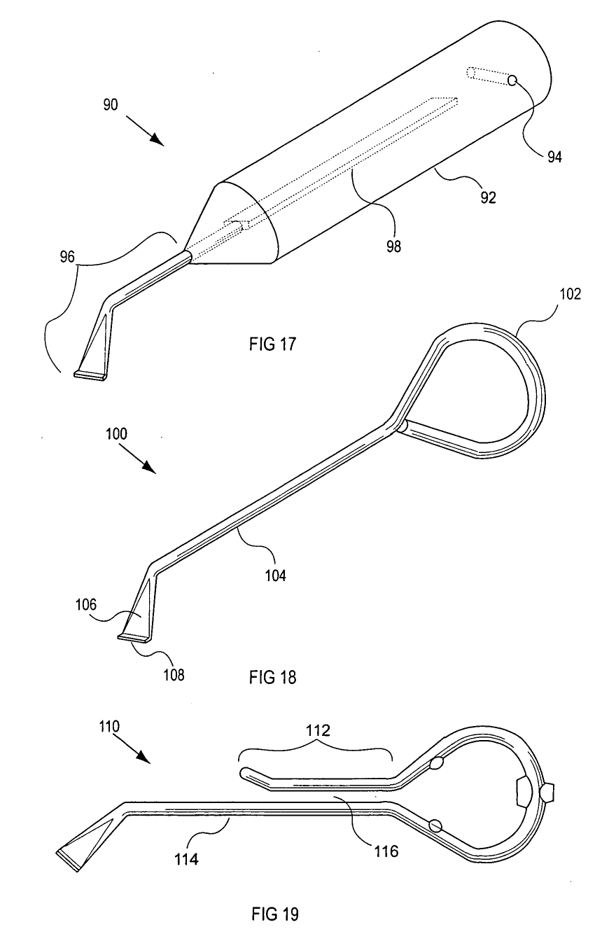

FIG. 17 shows a schematic diagram of further another embodiment of an opener in accordance with the present invention. As depicted, the opener 90 includes: a head portion 96 that is similar to the head portion 27 in FIG. 3; and a handle 92. The handle 92 is formed from conventional material, such as wood or plastic, and dimensioned to fit within the palm of a hand. Located within the handle 92 is an elongated member 98 that extends from the head portion 96. The handle 92 may include a throughpass hole 92 for hanging the opener 90 on a hanger mechanism. As a variation, the handle 92 may have geometry other than a simple cylinder. For instance, the circular cylindrical portion may include grip enhancing ridges.

FIG. 18 shows a schematic diagram of yet further another embodiment of an opener in accordance with the present invention. The opener 100 is similar to the opener 20 in FIG. 3, with the difference that the rod 104 may extend up to the loop 102, i.e., the thumb rest is not formed. Preferably, the loop 102 can be formed by bending one end portion of the rod 104, while the flange 106 and tip 108 are formed by flattening and bending the other end of the rod 104. It is also noted that the opener 100 may include optional configurations and tools described in conjunction with FIGS. 10-16.

FIG. 19 shows a schematic diagram of still further another embodiment of an opener in accordance with the present invention. The opener 110 is similar to the opener 100 in FIG. 18, with the difference that 1) the tip of the loop extends toward the head portion so that a clip 112 may be formed and 2) the loop includes protrusion components forming a beverage cap opener and a screw driver. The clip 112 is spaced apart from the rod 114 by a gap 116 and used to hang the opener 110 to a portion of a garment, such as pocket, by clipping action. The clip 112 has a slightly-bent tip to facilitate the engagement of the garment into the gap 116. It is noted that the opener 110 may include optional configurations and tools described in conjunction with FIGS. 13-14.

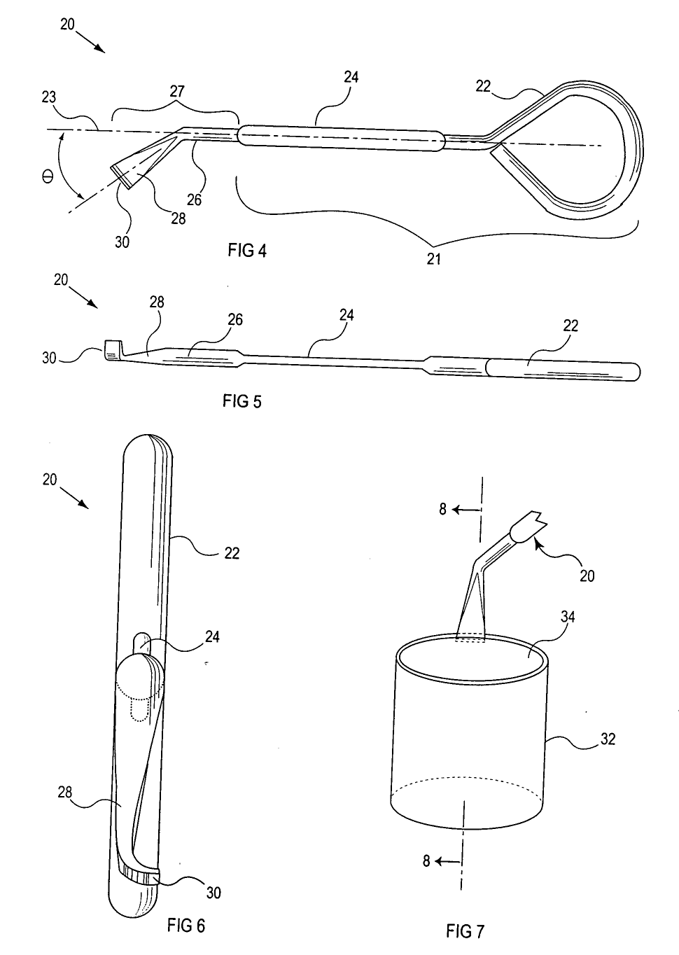

It is noted that the embodiments shown in FIGS. 3-18 are designed to be used by a right-handed person. Clearly, these embodiments can be modified for a left-handed person, i.e., the flanges (or tips) of these embodiments can be angled with respect to the rod in an opposite direction. For instance, in FIG. 4, the flange 28 can be bent in a counterclockwise direction with respect to the rod 26 by an angle θ. For another instance, in FIG. 10, the right side corner of the tip can be rounded. For still another instance, in FIGS. 15 and 16, the tips can be bent in a direction normal to the paper and away from the viewer.

It should be understood, of course, that the foregoing relates to exemplary embodiments of the invention and that modifications may be made without departing from the spirit and scope of the invention as set forth in the following claims.

1. A container lid opening tool, comprising:
a rod having an axial direction;
a loop formed at one end of said rod;
a flange having first and second ends, said first end being attached to the other end of said rod at a predetermined angle with respect to said axial direction, said loop being formed on a plane and said flange being substantially on said plane; and
a curved tip formed at said second end of said flange,
wherein a user of said tool holds said loop and a portion of said rod to repeatedly apply leverage force to a lid of a container thereby to pry the lid from the container.

2. A container lid opening tool as recited in claim 1, wherein said rod includes a flat portion to be used as a thumb rest.

3. A container lid opening tool as recited in claim 2, wherein a flat surface of said thumb rest is parallel to said plane.

4. (canceled)

5. A container lid opening tool as recited in claim 4, wherein said curved tip is bent out of said plane.

6. A container lid opening tool as recited in claim 1, wherein said angle is approximately 45 degrees.

7. A container lid opening tool as recited in claim 1, wherein said loop includes three protrusions formed along an inner side thereof and dimensioned to receive a portion of a beverage cap.

8. A container lid opening tool as recited in claim 1, wherein said loop includes a protrusion formed on an outer side thereof and to be used as a screw driver.

9. A container lid opening tool as recited in claim 1, wherein said loop includes a protrusion formed on an outer side thereof and to be used as a scraper.

10. A container lid opening tool as recited in claim 1, wherein said loop includes a snap.

11. A container lid opening tool as recited in claim 1, wherein said flange is tapered so that said second end is thinner and wider than said first end.

12. A container lid opening tool as recited in claim 1, wherein a portion of said loop extends toward the other end of said rod and forms a screw driver head.

13. A container lid opening tool as recited in claim 1, wherein a portion of said loop extends toward the other end of said rod and forms a clip for hanging said tool to a garment.

14. A container lid opening tool as recited in claim 1, wherein the tool is formed by bending and flattening portions of an elongated metal rod.

15. A container lid opening tool, comprising:
a rod having an axial direction;
a handle enclosing one end portion of said rod;
a flange having first and second ends, said first end being attached to the other end of said rod at a predetermined angle with respect to said axial direction; and
a curved tip formed at said second end of said flange and having a distal edge oriented in a direction substantially parallel to a plane defined by said axial direction and said flange, said flange being substantially on said plane,
wherein a user of said tool holds said handle to repeatedly apply leverage force to a lid of a container and thereby to pry the lid from the container.

16. A container lid opening tool as recited in claim 15, wherein said handle includes a through pass hole.

17. A container lid opening tool, comprising:
a rod having an axial direction;
a loop formed at one end of said rod;
a flange having first and second ends, said first end being attached to the other end of said rod at a predetermined angle with respect to said axial direction; and
a curved tip formed at said second end of said flange and having a distal edge oriented in a direction substantially parallel to a plane defined by said axial direction and said flange, said loop and said flange being substantially on said plane,
wherein a user of said tool holds said loop and a portion of said rod to repeatedly apply leverage force to a lid of a container thereby to pry the lid from the container.
